(19) United States
(12) Patent Application Publication
(10) Pub. No.: US 2021/0056481 A1
(43) Pub. Date: Feb. 25, 2021

(54) METHOD AND SYSTEM FOR GENERATING STAFFING REQUIREMENTS FOR DEFERRED WORK IN A CONTACT CENTER ENVIRONMENT

(71) Applicant: GENESYS TELECOMMUNICATIONS LABORATORIES, INC., Daly City, CA (US)

(72) Inventors: BAYU AJI WICAKSONO, LAUREL, MD (US); ANDY RAPHAEL GOUW, AUSTIN, TX (US); WEI XUN TER, ANNAPOLIS, MD (US)

(73) Assignee: GENESYS TELECOMMUNICATIONS LABORATORIES, INC., DALY CITY, CA (US)

(21) Appl. No.: 17/090,439

(22) Filed: Nov. 5, 2020

Related U.S. Application Data
(63) Continuation of application No. 14/858,626, filed on Sep. 18, 2015.
Application No. 14/858,626 is a continuation-in-part of application No. 14/829,796, filed on Aug. 19, 2015.
(60) Provisional application No. 62/089,988, filed on Dec. 10, 2014.

(51) Int. Cl. G06Q 10/06

(52) U.S. Cl. CPC G06Q 10/0639; H04M 3/5175; G06Q 10/067

(57) ABSTRACT

A system and method are presented for generating staffing requirements for deferred work in a contact center environment. In an embodiment, a simulation of deferred work performance is used to generate staffing requirement. Information, such as volume offered, expected handle time, available staff distributed throughout the intervals over a period of time, etc., are utilized for determining service performance metrics. The simulation accounts for transient data (e.g., number of deferred work handled or completed, number of backlog from an interval to the next, starting number of deferred work in the system, etc.) and determines performance metrics using that transient data.

### CLAIM OF PRIORITY AND CROSS REFERENCE TO RELATED APPLICATIONS

This application is a continuation of U.S. patent application Ser. No. 14/858,626, titled “METHOD AND SYSTEM FOR GENERATING STAFFING REQUIREMENTS FOR DEFERRED WORK IN A CONTACT CENTER ENVIRONMENT”, filed in the U.S. Patent and Trademark Office on Sep. 18, 2015, which is a continuation-in-part of U.S. patent application Ser. No. 14/829,796, titled “METHOD AND SYSTEM FOR GENERATING STAFFING REQUIREMENTS FOR DEFERRED WORK IN A CONTACT CENTER ENVIRONMENT”, filed in the U.S. Patent and Trademark Office on Aug. 19, 2015, which claims the benefit of U.S. Provisional Patent Application No. 62/089,988, titled “METHOD AND SYSTEM FOR GENERATING STAFFING REQUIREMENTS FOR DEFERRED WORK IN A CONTACT CENTER ENVIRONMENT”, filed in the U.S. Patent and Trademark Office on Dec. 10, 2014, the contents of which are all incorporated herein. This application is related to U.S. patent application Ser. No. 14/862,477, titled “METHOD AND SYSTEM FOR GENERATING STAFFING REQUIREMENTS FOR DEFERRED WORK IN A CONTACT CENTER ENVIRONMENT”, filed in the U.S. Patent and Trademark Office on Sep. 23, 2015.

The present invention generally relates to telecommunications systems and methods, as well as contact center environments. More particularly, the present invention pertains to staffing requirements in the contact center environments.

### SUMMARY

A system and method are presented for generating staffing requirements for deferred work in a contact center environment. In an embodiment, a simulation of deferred work performance is used to generate staffing requirement. Information, such as volume offered, expected handle time, available staff distributed throughout the intervals over a period of time, etc., are utilized for determining service performance metrics. The simulation accounts for transient data (e.g., number of deferred work handled or completed, number of backlog from an interval to the next, starting number of deferred work in the system, etc.) and determines performance metrics using that transient data.

In one embodiment, a method is presented for determining service performance metrics and assigning deferred work items by a workforce management system, the method comprising: automatically sourcing data from an Automatic Communication Distributor at an interval of time, wherein the interval of time comprises a handle time that is shorter than the interval of time, and wherein if the sourced data are at different time interval levels, normalizing the sourced data to the same level; iterating through the sourced data at the intervals of time to determine transient data; applying the transient data to produce service performance metrics for the contact center using a backtracking calculation, wherein a number of deferred work items completed for an interval of time is determined and number of deferred work items backlog for the interval of time is determined, and iterating from an interval of time to a next interval of time is performed to determine resolution time for each deferred work item and a wait time for the deferred work item; and assigning available deferred work items to available staff of the contact center with any unassigned work items added to a backlog queue such that a first deferred work item placed in the backlog queue is first to be assigned to an available staff.

In another embodiment, a method is presented for A method for determining service performance metrics and assigning deferred work items by a workforce management system, the method comprising: automatically sourcing data from an Automatic Communication Distributor at an interval of time, wherein the interval of time comprises a handle time that is shorter than the interval of time, and wherein if the sourced data are at different time interval levels, normalizing the sourced data to the same level; iterating through the sourced data at the intervals of time to determine transient data; applying the transient data, to produce service performance metrics for the contact center using a backtracking calculation, wherein a number of deferred work items completed for an interval of time is determined and number of deferred work items backlog for the interval of time is determined, and iterating from an interval of time to a next interval of time is performed to determine resolution time for each deferred work item and a wait time for the deferred work item; and assigning available deferred work items to available staff of the contact center with any unassigned work items added to a backlog queue such that the assigning comprises assigning deferred work items with a lowest completion percentage first from the backlog queue.

### BRIEF DESCRIPTION OF THE DRAWINGS

FIG. 1 is a diagram illustrating an embodiment of a typical telecommunications network within a contact center.

FIG. 2 is a diagram illustrating an embodiment of a modified telecommunications network within a contact center.

FIG. 3 is an embodiment of a process for determining deferred work performance with a short handle time.

FIG. 4 is an embodiment of a process for determining deferred work wait time and resolution time.

FIG. 5 is an embodiment of a process for determining load and resource assignment.

FIG. 6 is an embodiment of a process for determining hold and release.

FIG. 7 is an embodiment of a process for deferred work requirement search.

FIG. 8 is an embodiment of a decision tree for points exploration.

### CROSS-REFERENCE TO RELATED APPLICATIONS

This application claims priority to U.S. provisional application 62/089,988 filed Dec. 10, 2014, entitled “Method and System for Generating Staffing Requirements for Deferred Work in a Contact Center Environment”, the contents of which are incorporated herein, and is a continuation in part of U.S. application Ser. No. 14/829,796 filed Aug. 19, 2015 also entitled “Method and System for Generating Staffing Requirements for Deferred Work in a Contact Center Environment”.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

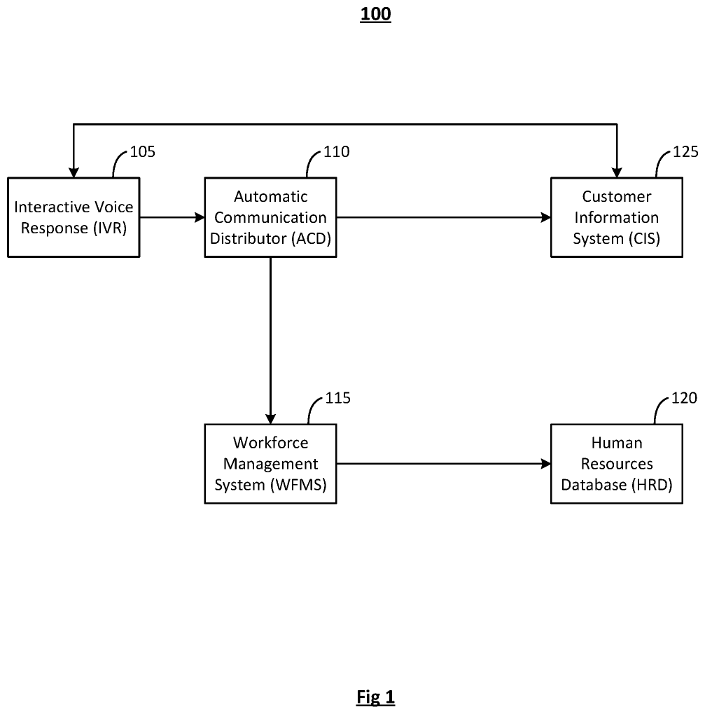

FIG. 1 is a diagram illustrating an embodiment of a typical telecommunications network within a contact center, indicated generally at 100. A typical telecommunications network within a contact center 100 known in the prior art includes an Interactive Voice Response system (IVR) 105, an Automatic Communication Distributor (ACD) 110, a Workforce Management System (WFMS) 115, a Human Resources Database (HRD) 120, and a Customer Information System (CIS) 125. The telecommunications network of some contact centers may vary from the telecommunications network 100 in that the data systems in the network may be combined and the infrastructure configuration may differ. Nevertheless, the function of the systems and the type of data residing in these other telecommunications networks is consistent with that residing in the telecommunications network 100, and therefore, the following discussion will also apply to these other networks.

The IVR 105 is an automated voice response system that is activated when a communication, such as a call, is received by the contact center. The IVR 105 provides a variety of options to a caller that are used to determine the purpose of the call and that are ultimately used to route the call to the appropriate resource. The IVR 105 also may obtain the caller's account or customer number (if one is available) and accesses the CIS 125 to determine how this caller should be treated based on the caller's account information (e.g., exposed to a tailored advertisement or, if a particularly good customer, routed to the best agent). The IVR sends the time called, the account number, the options chosen, and other data to the ACD 110 and to the CIS 125.

The ACD 110 automatically distributes the incoming communications, such as calls, to available resources within the telecommunications network 100 (e.g., agent telecommunication systems which may comprise phone agents and phone lines). In an embodiment, the network 100 may operate as part of a contact center at one or more physical locations which may be remote from each other. Agent telecommunication systems, or workstations, may be coupled to the network 100. Although not shown to preserve clarity, the workstations each include a workstation computer coupled to a display. Digital telephones are each associated with a different workstation. Each digital telephone may be connected to the network 100 through a network interface. In a further form, the connection to the network may be made first to the digital phone, then from the digital phone to the workstation computer by way of a pass-through connection on the digital phone or vice versa. Alternatively, two connections from the network can be made, one to the digital phone and one to the workstation computer. Additionally, in yet another form, digital telephones may be integrated into the agent computer and/or implemented in software. Each agent workstation may include one or more operator input devices, such as a keyboard, mouse, etc. Also, besides the display, one or more other output devices may be included such as loudspeaker(s) and/or a printer.

The ACD 110 also sends call interval data to the WFMS 115 (i.e., call data summarized by a particular unit of time, such as by half-hour). The call interval data includes, for each interval, call volume (e.g., 400 calls), number of phone agents available, number of phone agents occupied by handling calls, average handle time (e.g., 2 minutes), number of abandons, the mean time to abandon, the average wait time, service level (e.g. of the proportion of calls answered in less than or equal to a specified number of seconds, such as 80% within 20 seconds, for example), and the average call duration. The ACD 110 also sends call-by-call data to the CIS 125. The call-by-call data includes the wait time of the call, the employee that handled the call, the handle time of the call, the time to abandon (if applicable), the amount of after call work or casework required, and details on the customer order, purchases, or other activity (if applicable).

The ACD 110 may also send other contact interval data to the WFMS 115, such as deferred work. Examples of deferred work may include e-mails and back-office work.

WFMS 115 forecasts contact volumes and handle times and develops employee schedules in such a manner that resources are available to answer or process the incoming flow of contacts. The WFMS 115 uses generic forecasting techniques such as moving averages or autoregressive integrated moving average (ARIMA) models to predict, for any future day, the number of contacts the center can expect. The WFMS 115 then determines the phone agent staffing levels by time of day that will result in the center's meeting an overall service standard goal for the forecasted number of contacts. Shift optimization determinations are then used to determine the shifts that will best cover the estimated staffing requirements. The WFMS 115 also provides processes to monitor phone agent productivity and to allow phone agents to select and manage their weekly work-shifts. The WFMS 115 sends schedules, shift swaps, schedule adherence, and hours worked data to the HRD 120.

The HRD 120 tracks payroll information and the number of hours worked by phone agents. Specifically, the HRD 120 tracks schedules, shifts, schedule adherence, hours worked, vacation accrued, salary information, and hiring costs. The HRD 120 receives the forecast from the WFMS 115 and uses it to determine when to hire new employees and when to schedule training classes.

The CIS 125 incorporates customer account information including customer segmentation and customer value and gathers call-by-call data from the ACD 110 into a common computer database. The CIS 125 delivers account information such as customer value to the IVR 105 in order to assign an appropriate treatment for a given caller (e.g., if the customer is highly valued, route the call to the best agent).

The typical telecommunications network within a contact center 100 is not able to generate rapid analysis and plans for staffing, budgeting, call handling, and service quality goal setting. Nothing in the typical telecommunications network 100 allows the management of a contact center to quickly and accurately know the effects on contact center performance of changes in staff, budgets, call handling, and service goals. The analytic techniques used in a typical telecommunications network within a contact center 100 are not able to perform these analyses because they are either too simplistic for these types of scenarios (e.g., Erlang C) or too slow for rapid “what-if” analysis (e.g., discrete-event simulation).

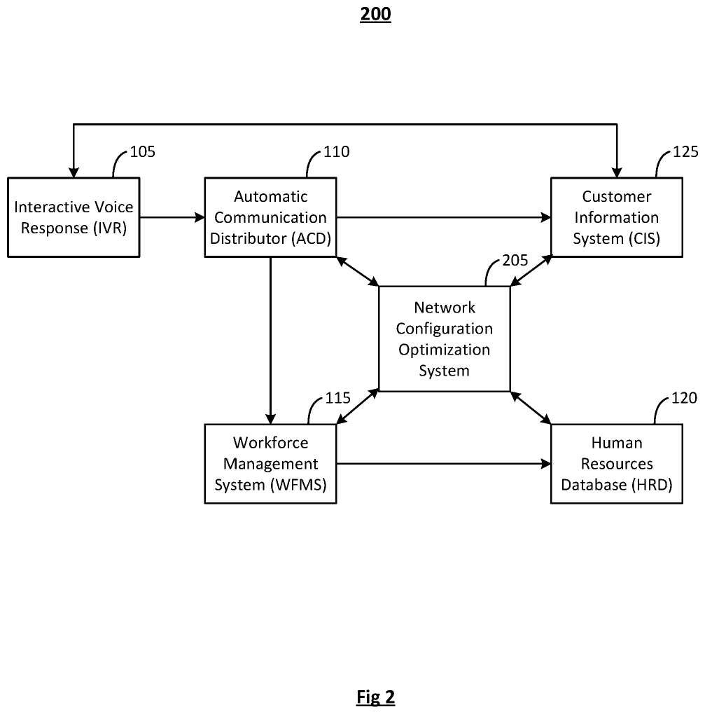

Referring to FIG. 2, one implementation of a telecommunications network within a contact center 200 is shown that includes the typical performance monitoring and analysis components associated with the telecommunications network 100 with an additional interconnected Network Configuration Optimization System 205. The Network Configuration Optimization System 205 exchanges performance data and performance history data with the performance monitoring systems in the telecommunications network 100 and produces rapid analyses and plans for staffing, budgeting, call handling, and service quality goal setting. While the exemplary implementation of the telecommunications network is within a contact center system, it should be understood that the telecommunications network may include any type of system in which work is handled by a workforce having a finite number of resources. Such systems may include, but not be limited to, operations that handle and process incoming e-mail messages and inquiries, facsimile messages, insurance claims, and financial instruments including checks and coupons.

The Network Configuration Optimization System 205 receives performance information directly from all of the performance monitoring systems in the telecommunications network 100 with the exception of the IVR 105. Specifically, the ACD 110 provides the Network Configuration Optimization System 205 with regular feeds of call interval data. The Network Configuration Optimization System 205 may, alternatively, receive call interval data from the WFMS 115 rather than the ACD 110. The WFMS 115 provides the Network Configuration Optimization System 205 with periodic feeds of the latest contact volume forecast including the contact volume (e.g., call volume) and handle time forecast. The WFMS 115 also may provide the Network Configuration Optimization System 205 with a schedule adherence forecast. The HRD 120 provides the Network Configuration Optimization System 205 with agent salary information and hiring costs that may be accessed by the system 205 as needed. Finally, the CIS 125 provides the Network Configuration Optimization System 205 with customer segmentation, customer value, and call-by-call data.

The Network Configuration Optimization System 205 also sends information back to all of the performance monitoring systems in the telecommunications network 200. Specifically, the Network Configuration Optimization System 205 sends the call routing plan (e.g. how best to route different types of calls) back to the analysts who manage the ACD 110. The Network Configuration Optimization System 205 provides the WFMS 115 with the staffing plan. The staffing plan includes the hiring plan; the number of vacation, sick, and training days; the number of agents transferred between management units; and the skills of the agents (e.g. able to speak Spanish or that can handle complex requests well). The WFMS 115 incorporates all of this information into the staffing schedule. The Network Configuration Optimization System 205 also provides the staffing plan to the HRD 120 and its analysts along with a budget estimate corresponding to that staffing plan.

Finally, the Network Configuration Optimization System 205 provides a series of customer reports to the CIS 125 and its analysts that show the experience that each customer segment has had with the contact center in the past and, given the current staffing plan, the experience each customer segment is expected to have in the future. The reports may contain the following for each customer segment: the service level, the call wait time, the probability of abandon, the mean time to abandon, the cost of abandon, the average handle time, the customer value, the distribution of call purpose, and a customer satisfaction measure.

In an embodiment, the Network Configuration Optimization System 205 may further comprise a module for deferred work performance simulation. The Network Configuration Optimization System 205 may further comprise a staffing requirement generation engine. The deferred work performance simulation module may be used by the staffing requirement generation engine to determine staffing requirements for a contact center environment, which is described in greater detail below.

In a typical WFMS 115 that performs the process of scheduling agents in telecommunications networks within contact centers, for example, simulation (or mathematical/probabilistic) models are created to optimize the service performance goals for the lowest cost possible. Models are created for all possible contact/interaction types, such as customer service chats, sales calls, support e-mails, etc., in order to optimize the service performance goals for the lowest cost possible. Typical service performance goals may be: 80% of calls handled within 20 seconds or 100% of e-mails handled within 24 hours. In order to achieve these goals, for example, the WFMS 115 has to predict the interaction load and schedule the agents necessary while conforming to the customers' agent constraints. The accuracy may then be judged by whether or not service performance goals are met and by how many agent hours it schedules to achieve that.

Immediate work, such as inbound call or chat may be treated very differently than deferred work, such as email or back-office work. In the case of immediate work, performance measurement is straight-forward and can be easily aggregated to a certain reporting period or interval. This is because of the nature of the immediate work where contacts that are not handled are abandoned (i.e., does not stay in the system). However, in the case of deferred work, such as e-mail, this work is not abandoned, thus making performance measurement much more difficult. Not only is the Service Level Agreement (SLA) threshold significantly longer for deferred work than for an inbound call, but service level rules (i.e., every e-mail will eventually get handled) cannot be applied to e-mail planning because of backlogs.

The definition of service level between immediate and deferred work are very different. While immediate work measures service level with respect to works offered during a specific time period (i.e., calls handled within certain threshold/calls offered in a day), deferred work service level is often determined with respect to total work handled which could include backlogs from previous period(s) (i.e., works handled within certain threshold/total works handled). The differences further broaden as period over period relationships are considered. Immediate work, where service level of any period is independent, is unlike deferred work. With regards to deferred work, service level for one period may be correlated to the preceding period(s) as well as the following period(s) due to backlogs. Backlogs comprise work that cannot be completed within the period and ‘overflows’ to the next period(s), such as e-mail messages, e-mail inquiries, facsimile messages, insurance claims, and financial instruments, to name a few non-limiting examples. Consequently, the concept of service level as applicable for immediate work, as well as any inference of it, is not suitable for deferred work analysis. As a result, staffing is more problematic when dealing with deferred work such as e-mail.

Staffing to only a service level may achieve high service level in the first few periods, but the backlog will begin to build up. As work needs to be done in a first-in-first-out (FIFO) fashion, lower service levels in later periods may result or excessively high staffing numbers are achieved. Even if steady volume is assumed, staffing to only service level can result in fluctuating staffing results. This is not desirable in a contact center environment because of hiring constraints (e.g., not being able to hire fast enough) and/or business policies (e.g., agents can only work a certain number of overtime hours). Therefore, deferred work cannot be staffed just to service level, unlike inbound calls or chats. Alternative performance measurements may be used such as maximum resolution time, average resolution time, percentage completion time, throughput rate, average wait time, and average beginning backlog.

The maximum resolution time may comprise the maximum time in which all deferred work are guaranteed to be 100% completed. The average resolution time comprises the average time in which all deferred work are completed. The percentage completion time may comprise the time in which a percentage of deferred work is done. The throughput rate comprises the number of deferred work completed per time interval (e.g. per hour, per day, per week, etc.). The average wait time comprises the average time in which all deferred work waited before being worked. It should be noted that wait time may be equivalent to resolution time in some embodiments. The wait time may be defined as the handle time subtracted from the resolution time. The average beginning backlog may be described as the average number of backlog at the beginning of a time interval (e.g., beginning of an hour, day, week, etc.).

In an embodiment, deferred work performance metrics may be determined and used to generate the staffing requirement for a contact center environment.

### Deferred Work Performance Simulation

In an embodiment, deferred work performance simulation may be determined from input such as: volume offered, expected handle time, and the number of available staff distributed throughout the intervals over a period of time (e.g., a week, a month, a quarter of the year, etc.). Service performance metrics may be determined from these inputs. A simulator may be utilized which steps through the time intervals and keeps track of and accumulates collections of important transient data. Such transient data may comprise the number of deferred work handled (or completed), the number of backlogs from one interval to the next, and the starting number of deferred work in the system. In an embodiment, a backtracking calculation may be used to determine performance metrics from those transient data. Simulation takes into account shorter handle times (i.e., less than one interval period), as well as a longer handle time that spans multiple intervals by ensuring available staff resources cannot handle more work than feasible.

Deferred work performance simulation utilizes a number of inputs, including, for example: number of deferred work offered, average elapsed time of deferred work, average effective handle time of deferred work, number of available staff, and input distribution. The number of deferred work offered comprises the total number of deferred work offered to a queue. The average elapsed time of deferred work comprises the average amount of elapsed time taken for a deferred work to be completed once work has been initiated. Delays and non-active agent time between start and completion are also taken into account.

Average effective handle time of deferred work comprises the average amount of work time an agent takes in order to complete a deferred work. The average effective handle time metric does not include delays or non-active agent time between the start and completion of a deferred work. The number of available staff comprises the total number of agent hours available to work on deferred work. Input distribution comprises a set of factors for each time interval of a collection of time period that define the typical distribution of intervals input throughout a time period. The input distribution metric may be used to distribute inputs to the same time period in which the model is built.

Inputs may be at a time interval level (e.g. hourly, daily, weekly, monthly, etc.) depending on what level of final performance metrics are sought and also dependent on the forecaster's planning period. If the inputs being sourced are at a different time interval level, then a way is needed to normalize or distribute the inputs to the same level as the determination of the final performance metrics. Input distributions may be utilized in this manner. Examples of input distributions comprise a set of factors for each time interval of a collection of a time period that defines the typical distribution of intervals input throughout a time period, such as: weekly contact volume distribution, daily contact volume distribution, weekly average handle time distribution, daily average handle time distribution, weekly staff availability distribution, and daily staff availability distribution.

A weekly contact volume distribution may comprise a set of factors for each interval within the day-of-the-week that defines the typical distribution of contact arrival throughout the week. Each factor measures the average percentage of contact volume in that interval (such as hourly or 15-30-minute intervals) of the day from the total call volume for the week as a whole. The weekly contact volume distribution may be used to derive the daily contact volume distribution by normalizing the sum of factors at the day-of-the-week level. Daily contact volume distribution may comprise a set of factors for each interval within the day-of-the-week that defines the typical distribution of contact arrival throughout that day-of-the-week. In an embodiment, each factor measures the average percentage of contact volume in that interval (such as hourly or 15-30-minute intervals) of the day from the total call volume for the day-of-the-week as a whole.

Weekly average handle time distribution comprises a set of factors for each interval within the day-of-the-week that defines the typical distribution of average handle times throughout the week. Each factor measures how far the average handle time in the interval (such as hourly or 15-/30-minute intervals) deviates from the average handle time of the week as a whole.

The daily average handle time distribution comprises a set of factors for each interval within the day-of-the-week that defines the typical distribution of average handle times throughout the day-of-the-week. For example, each factor measures how far the average handle time in the hour deviates from the average handle time of the day-of-the-week as a whole.

The weekly staff availability distribution comprises a set of factors for each interval within the day-of-the-week that defines the typical distribution of staff availability throughout the week. For example, each factor measures the average percentage of available staff in that interval for the day from the total available staff for the week as a whole. The weekly staff availability distribution may be used to derive the daily staff availability distribution by normalizing the sum of factors at the day-of-the-week level.

The daily staff availability distribution comprises a set of factors for each interval within the day-of-the-week that defines the typical distribution of staff availability throughout that day-of-the-week. For example, each factor measures the average percentage of available staff in that interval from the total available staff for that day-of-the-week as a whole.

Data may be sourced for the simulation at one or more collection periods lower than the level of planning. For instance, if planning is done or aggregated at the daily level, then hourly data may be sourced. If daily data is used, a distribution may be applied to convert those daily data to hourly data.

Using any of the above described inputs, outputs may be determined by the deferred work simulation module including, but not limited to: deferred work completed, maximum resolution time, average resolution time, average wait time, backlog, and occupancy. The deferred work completed comprises the total number of deferred work being completed. The maximum resolution time comprises the maximum time in which all of the deferred work are 100% completed. The average resolution time comprises the average time in which deferred work is completed. The average wait time comprises the average time in which deferred work waited in queue before being worked on. Backlog comprises the number of deferred work backlog at the beginning or the ending of a time interval. Finally, occupancy comprises the percentage of time agents spend handling deferred work compared with the total amount of time they are available, waiting for deferred work to arrive.

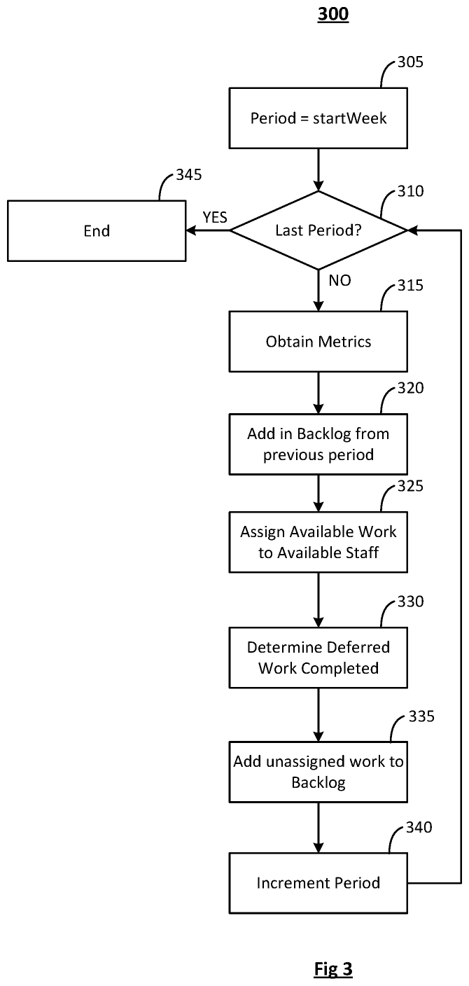

For deferred work that has a shorter handle time, such as handle time less than the period interval, an assumption may be made that any work started in one period interval must be finished in the same or at most, the next period interval. The simulation module tracks work moving in and out of each interval instead of the actual work itself and its various stats throughout the time horizon. The system will first iterate through all of the periods where there is deferred work offered and assigns this to the available staff according to the handle time. In an embodiment, this may be done using the first-in-first-out (FIFO) rule. From one interval to the next, the simulation module is able to determine the number of deferred work being completed in each of the periods as well as the backlog at the end of the period. FIG. 3 is an embodiment of a process for determining deferred work performance with a short handle time, indicated generally at 300. This process may occur in the performance simulation module of the Network Configuration Optimization System 205 (FIG. 2).

In operation 305, the simulation module begins with the first period. For example, the first period may be determined either manually or automatically. The first period may be user defined or determined by the system. In an embodiment, the start date/period of a planning scenario may comprise the first period. In another embodiment, the first period may comprise a start date/period of a specific query. Control is passed to operation 310 and process 300 continues.

In operation 310, it is determined whether or not the first period is also the last period. If it is determined that the first period is not the last period, control is passed to operation 315 and process 300 continues. If it is determined that the first period is the last period, control is passed to operation 345 and the process 300 ends.

The determination made in operation 310 may be based on any suitable criteria. For example, the last period may be defined either manually by a user or automatically, such as by the system, and be the same as the first period.

In operation 315, metrics are obtained. For example, metrics such as deferred work volume, average handle time, and staff full-time-equivalent may be obtained from the ACD 110. Metrics may also be obtained from the WFMS 115 and the HRD 120. In another embodiment, metrics may also be input by a user of the system. Control is passed to operation 320 and process 300 continues.

In operation 320, backlog from the previous period is accounted for. For example, the system may add in work in the backlog from the previous period. Control is passed to operation 325 and process 300 continues.

In operation 325, available work is assigned to available staff. For example, available e-mail or other deferrable work may be assigned to available staff by the simulation module. Control is passed to operation 330 and process 300 continues.

In operation 330, deferred work completed is accounted for. The number of deferred work completed comprises the total number of deferred work being completed. In an embodiment, the total number of deferred work being completed may be determined from the amount of available staff at a particular interval or period versus the workload. The number of deferred work completed is taken into account by the simulation module. Control is passed to operation 335 and process 300 continues.

In operation 335, unassigned work is added to the backlog. For example, the unassigned work may be added to the backlog according to FIFO rules such that the first deferred work that will later be completed is the very first deferred work that has waited the longest in the queue. Control is passed to operation 340 and process 300 continues.

In operation 340, the simulation module moves to the next period. Control is passed back to operation 310 and process 300 continues.

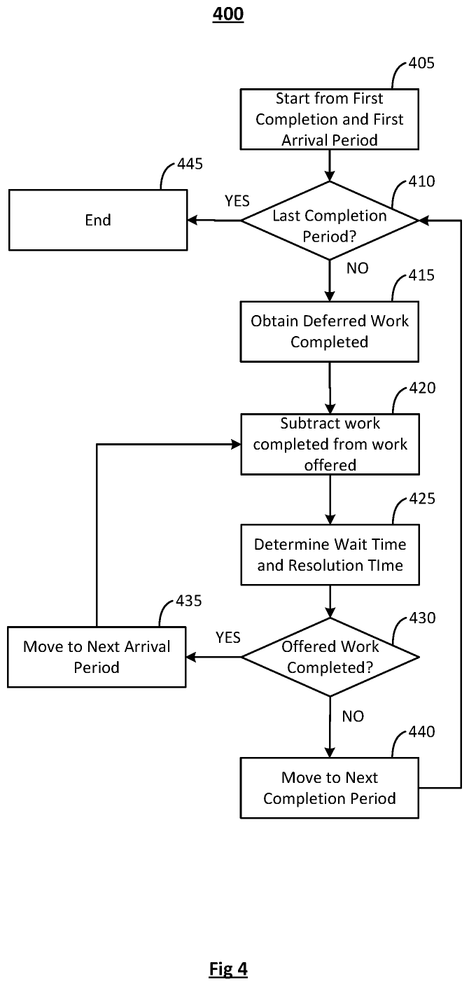

After the number of deferred work completed and the number of deferred work backlog for each period are determined, the remainder of the performance metrics can be determined by a second process that backtracks from one period to the next period, as further described in FIG. 4. Since deferred work are being completed according to FIFO rules, the number of arrival and the number of completion of each period can be compared. The simulation module can thus determine the resolution time of each deferred work, as well as the wait time.

FIG. 4 is an embodiment of a process for determining deferred work wait time and resolution time, indicated generally at 400. This process may occur in the performance simulation module of the Network Configuration Optimization System 205 (FIG. 2).

In operation 405, the simulation module begins with the first completion period and the first arrival period. For example, the first completion period and the first arrival period may be user defined or automatically determined by the system. Control is passed to operation 410 and process 400 continues.

In operation 410, it is determined whether or not the first completion period is also the last completion period. If it is determined that the first completion period is not the last completion period, control is passed to operation 415 and process 400 continues. If it is determined that the first completion period is the last completion period, control is passed to operation 445 and the process 400 ends.

The determination in operation 410 may be made based on any suitable criteria. For example, the last completion period may be defined either manually by a user or automatically, such as by the system, and be the same as the first completion period.

In operation 415, the number of deferred work completed is obtained. The number of deferred work completed comprises the total number of deferred work being completed. This is taken into account by the simulation module and is obtained during operation 330 of the process 300 as previously described (FIG. 3). Control is passed to operation 420 and process 400 continues.

In operation 420, the number of work completed is subtracted from the number of work offered in this arrival period. Control is passed to operation 425 and process 400 continues.

In operation 425, the wait time and resolution time are determined. For example, the wait time may be determined by subtracting the arrival period from the completion period. The resolution time may be determined by summing the wait time and the handle time. Control is passed to operation 430 and process 400 continues.

In operation 430, it is determined whether all offered work has been completed. If it is determined that all offered work has been completed, control is passed to operation 435 and the process 400 continues. If it is determined that all offered work has not been completed, control is passed to operation 440 and process 400 continues.

The determination in operation 430 may be made based on any suitable criteria. For example, there may be no more work in the queue.

In operation 435, the system moves to the next arrival period and control is passed to operation 420. Process 400 continues.

In operation 440, the system moves to the next completion period and control is passed to operation 410. Process 400 continues.

The simulation module may be used in part of the deferred work staffing requirement generation engine, described in further detail below, to determine and evaluate potential solutions in search for a deferred work staffing requirement. For deferred work that has a longer handle time (handle time greater than period interval), an assumption may be that any work that is started in one period interval might not finish in the same or the subsequent period interval. Work in Progress (WIP) is created that often spans multiple period intervals. In order to capture or determine the service performance in this sort of scenario, load and resource matching and hold and release are employed.

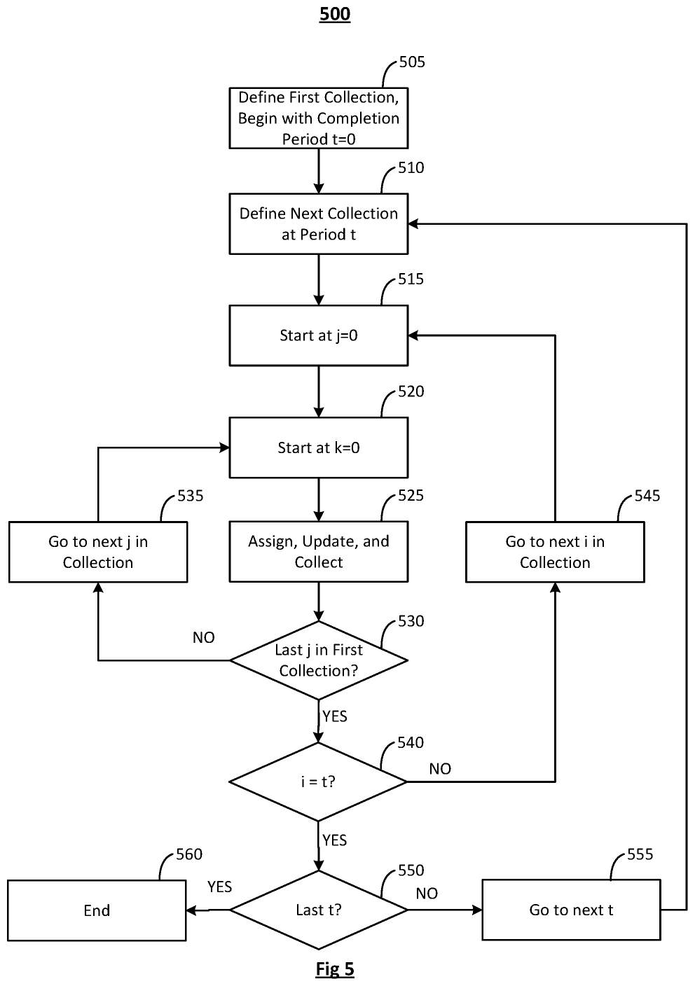

FIG. 5 is an embodiment of a process for determining load and resource assignment, indicated generally at 500. Load and resource assignment determines performance of deferred work with longer handle times through simulation by a means of tracking percentage completion of each deferred work. Assuming first-in-first-served (FIFS) where deferred work that arrived first will be worked on first, resources (i.e. available staff) are matched to the load (i.e. deferred work offered) for each period interval depending on the completion status of the load as well as the availability of the resource.

Since the amount of deferred work and available staff in the system may be imbalanced, most deferred work might be worked to a different completion percentage and finished at a different pace. This difference is captured and the deferred work that is worked to a different completion percentage are separated into different pools and individually tracked. Due to the deferred work pool with different completion percentages, portions of the staff may be able to complete certain pool(s) of deferred work resulting in having spare time to start on un-touched deferred work. In an embodiment, extra resources may be captured into different pools and allocated to deferred work not started.

In an embodiment, the following collections may be used to achieve grouping of loads and resources into different pools while tracking the status of deferred work in progress. A collection may comprise a list, array, dictionary, etc. A first collection may comprise a work collection, such as a persistent collection, to track the load in each period interval with respect to their completion pool. A deferred work pool comprises a grouping of work that experiences similar completion status, such that all work in the same pool has the same work completion percentage. In an embodiment, the pool with the lowest index is the pool with the highest work completion. A second collection may comprise a staff, or temporary, collection that exists when accessing how work is done at a particular period interval. In an embodiment, the second collection may track the number of staff available for a particular interval/period with respect to their throughput pool. A staff pool may comprise a grouping of available resources, with similar throughput rate/availability, such that the lowest index comprises the pool with the highest throughput rate/availability. In an embodiment, the second collection may be purged and reset at the beginning of each period since this resource cannot be deferred. This may comprise available resources, which cannot be deferred, and is purged and reset at the beginning of each period.

In the first collection, for example, the number of work and the work completion percentage of each pool are updated as time progresses and additional pools may be created as necessary. Pools with 100% work completion are considered completed and service performance may be determined according to the period interval at which it reaches 100% such that:

CollectionOfWork[i][j]

where i arrival period index, j deferred work pool index

Fields: i) #Work: Total Number of Work in pool j in period i, ii) Work Completion %: Work completion % of Work in pool j in period i.

In the second collection, for example, the resource (e.g. available staff) is tracked in a particular period interval with respect to the resource's throughput pool. A staff pool may comprise a group of staff that provide similar throughput rates, such that all staff in the same pool will have the same throughput rate. In an embodiment, the pool with the lowest index is the pool with the highest throughput rate. When assigning staff to a deferred work, the number of staff and the throughput rate are updated where new pools are created as necessary. Pools with the highest throughput rate are paired up with deferred work first and any pool where staff number is zero are removed such that:

CollectionOfStaff[i][j]

where k=staff pool index

Fields: i) #Staff: number of staff in throughput pool k, ii) Throughput Rate: the throughput rate of the staff in throughput pool k.

In an embodiment, the second collection may be purged and reset at the beginning of each period since this resource cannot be deferred.

In operation 505, a work collection is defined. For example, the first collection (as previously described) may be applied at completion period t=0. In an embodiment, the work collection may comprise a persistent collection. Control is passed to operation 510 and process 500 continues.

In operation 510, a staff collection is defined. For example, the second collection (as previously described) may be applied at a period t. In an embodiment, this collection may be temporary. Control is passed to operation 515 and process 500 continues.

In operation 515, the deferred work pool index begins with zero. Control is passed to operation 520 and process 500 continues.

In operation 520, the staff pool index begins with zero. Control is passed to operation 525 and process 500 continues.

In operation 525, the number of work in the work collection, or persistent collection, is assigned to the number of staff in the staff collection, which may also be a staff or temporary collection. For example, the work and staff collections may then be updated and service performance is determined. Control is passed to operation 530 and process 500 continues.

In operation 530, it is determined whether or not the last deferred work pool index is the last in the work collection. If it is determined that the last deferred work pool index is the last in the work collection, control is passed to operation 540 and process 500 continues. If it is determined that the last deferred work pool index is not the last in the work collection, control is passed to operation 535 and the process 500 continues.

The determination in operation 530 may be made in any suitable manner. For example, the size of the collection is known and it is the last index in the collection.

In operation 535, the system moves to the next deferred work pool index in the collection. Control is passed back to operation 520 and the process 500 continues.

In an embodiment, operations 520 through operations 530 may run in a loop which iterates through all deferred work pool indexes in a period i.

In operation 540, it is determined whether the arrival period index is equivalent to the completion period t. If it is determined that the arrival period index is equivalent to the completion period t, control is passed to operation 550 and process 500 continues. If it is determined that the arrival period index is not equivalent to the completion period t, control is passed to operation 545 and process 500 continues.

The determination in operation 540 may be based on any suitable criteria. For example, the arrival period index may be equivalent to the completion period t when the i^{th} index in the CollectionOfWork[i][j] collection is reached and the index i is equal to the period t.

In operation 545, the system moves to the next arrival period index in the collection. Control is passed back to operation 515 and the process 500 continues.

Operations 515 through 545 may run in a loop which iterates through all arrival period indexes earlier than a completion period t.

In operation 550, it is determined whether the completion period t is the last completion period. If it is determined that the completion period t is the last completion period, control is passed to operation 560 and process 500 ends. If it is determined that the completion period t is not the last completion period, control is passed to operation 555 and operation 500 continues.

The determination in operation 550 may be made based on any suitable criteria. For example, the last period may be defined either manually by a user or automatically, such as by the system.

In operation 555, the system moves to the next completion period t. Control is passed back to operation 510 and the process 500 continues.

In an embodiment, operations 510 through 555 may run in a loop which iterates through all completion period t in a scenario.

During the assignment process, the system proceeds through completion time with matching the deferred work pool that has the lowest completion percentage with the staff in each completion period. In an embodiment, the staffing collection only has one entry at the start of each completion period, containing the total staff available as well as the throughput rate at that completion period (i.e. #Staff in CollectionOfStaff[0]=Number of staff in this completion period with throughput rate equal to 1/AHT.

In an embodiment, as the matching process progresses, a plurality of situations may occur. In one situation, the number of work in the deferred work pool with the lowest completion percentage is greater than the number of staff in a staff pool. Only the portion of the number of work equal to the number of staff would be worked, resulting in some portion of work not being worked. The works are thus separated into a number of different pools, such as two, for example. The first pool may contain the amount of work that can be worked and the second contains the amount of work that cannot be worked. The pool with the amount of work that can be worked has the work completion percentage incremented by the amount of the throughput rate of CollectionOfStaff[k=0], where k represents an index of the array CollectionOfStaff[k]. At the same time, if work completion percent were to exceed 100%, only the amount of throughput rate equal to the amount needed to reach 100% is assigned and the left over throughput rate is retained in a separate staff pool. This becomes assignable to the next work pool if available.

In another situation, the number of work in the longest waited deferred work pool is less than the number of staff in pool CollectionOfStaff[k=0]. Since the amount of work is less than the number of staff, all work will be worked. Thus, the work will not be separated into a different pool. Rather, the work completion percentage will just be incremented by the amount of the throughput rate of CollectionOfStaff[k=0]. Since there would be excess staff, the staff will be split into a number of pools. In a non-limiting example, the number of pools may be two. One pool will be the staff that do not work on the work. The second pool comprises the staff that worked on the work. Because the first pool did not work on any work and did not contribute any throughput rate, the throughput rate remains the same. For the second pool of staff which were matched and contributed, the throughput rate of the work completion percentage for work, after adding the contributed throughput rate, is less than or equal to 100%. This pool thus no longer provides assignable resources and is removed. In situations where the work completion percentage exceeds 100%, only the amount of throughput rate equal to the amount needed to reach 100% is assigned and the left over throughput rate is retained in a separate staff pool. This is assignable to the next work pool if available.

Throughout the assignment and update process on the tracking collections, service performance output is automatically updated because at each period interval, the full spectrum of fields (such as work that is completed and work that is 0% completed) is exact. The resolution time may be determined by taking the difference of the period where any work pool is 100% completion against the respective arrival period. From the calculated resolution time, values for the maximum resolution time, average resolution time, and average wait time can be determined by aggregation. Occupancy of each completion period is determined by the amount of unassigned throughput versus the original available throughput.

While the resource and load matching process described in process 500 attempts to track the percentage of completion of each deferred work, the hold and release process tracks percentage completion at the interval period level without the need to track individual or pool of deferred work. A completion percentage is assigned to a period interval, where every deferred work is assumed to have the same completion percentage. As the time progresses, completion percentage is added to each period depending on the available staff and its throughput rate. The deferred work are on “hold” while completion percentage of a period interval is lower than 100%. When completion percentage reaches 100%, deferred work are considered completed and “released”. By assuming first-in-first-completed (FIFC) where deferred work that arrives first is completed first, the performance of the “released” completed work is calculated accordingly to the period interval at which they first arrived utilizing tracking properties such as: number of WIP, number of work not started (backlog), total number of work, work completion percentage, amount of WIP completed, and total amount of WIP completed. These tracking properties may be tracked throughout each period interval.

The WIP comprises the number of work that had started but has yet to be completed in the system while the backlog comprises the number of work in backlog that has yet to be started in the system. The total number of work comprises the total number of work that is in the system at the beginning of a period interval. The total number of work comprises the sum of the number of work that arrive in a particular period plus the WIP and backlog which are in the system at the beginning of a period interval.

The work completion percentage comprises the percentage at which the WIP is done. Since long handle time spans multiple intervals, only a percent of the work is actually done in one particular interval. This percentage explains the portion of work that is put into the WIP. The amount of WIP completed comprises the amount of work done on the WIP of a particular interval. The amount of WIP completed comprises the product of the number of WIP with respect to its work completion percentage. For example, if 50% of 5 works and 20% of 10 works are done in a period interval, the amount of work completed would be: 5*0.5+10*0.2 which equals 4.5 work for this period interval. This is not the same as number of work completed, which is the count of works that are fully completed 100%. The total amount of WIP completed comprises the sum of all work done on the WIP in the system. It comprises the aggregation of the amount of WIP completed of each preceding interval. For example, if 50% of 5 works and 20% of 10 works are done in the first period and 20% of 5 works and 40% of 10 works are done in the second period, the total amount of WIP completed in the second period equals the amount of WIP completed in the first period added to the amount of WIP completed in the second period. This is equal to: (5*0.5+10*0.2)+(5*0.2+10*0.4), or 9.5 work.

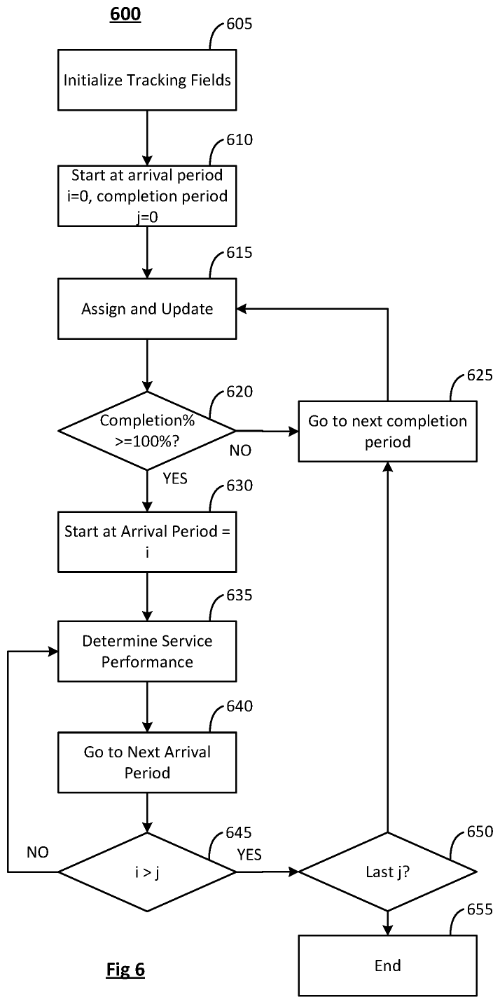

Utilizing the tracking properties described above, each individual deferred work, work through the progress of first being offered and to being handled, and finally to being completed, may be tracked. FIG. 6 is an embodiment of a process for determining hold and release, indicated generally at 600.

In operation 605, tracking fields are initialized. For example, the fields that are desired to be tracked by a user may be set up, such as the number of WIP, number of work not started (backlog), total number of work, work completion percentage, amount of WIP completed, and total amount of WIP completed. Control is passed to operation 610 and process 600 continues.

In operation 610, the system determines and begins with the initial arrival period (i=0) and the initial completion period (j=0). Control is passed to operation 615 and process 600 continues.

In operation 615, assignments and updates are processed. For example, the number of staff are assigned to work and the tracking fields are updated. Control is passed to operation 620 and process 600 continues.

In operation 620, it is determined whether completion percentage is greater than or equal to 100%. If the completion percentage is less than 100%, control is passed to 625 and process 600 continues. If the completion percentage is less than or equal to 100%, control is passed to operation 630 and process 600 continues. The process accumulates work throughout completion time until the completion percent reaches 100%.

In operation 625, the next completion period is examined. Control is passed back to operation 615 and process 600 continues. Operations 615 through 625 may run in a loop such that the loop is iterated through all completion periods until the work completion percentage is greater than 100%.

In operation 630, the system examines arrival period=i. Control is passed to operation 635 and process 600 continues.

In operation 635, service performance is determined. For example, the determination of service performance may be similar to the process 400 through a backtracking mechanism. Control is passed to operation 640 and process 600 continues.

In operation 640, the system increments to the next arrival period. Control is passed to operation 645 and process 600 continues.

In operation 645, it is determined whether the arrival period index i is greater than the completion period index j. If it is determined that the arrival period index is greater than the completion period index, control is passed to operation 650 and process 600 continues. If it is determination that the arrival period index is not greater than the completion period index, control is passed back to operation 635 and process 600 continues.

Operations 635 through 645 may run in a loop such that the loop is iterated through all arrival periods i, which is prior to completion period j, to calculate performance.

In operation 650, it is determined whether or not the last completion period is being examined. If it is determined that the last completion period is being examined, control is passed to operation 655 and the process ends. If it is determined that the last completion period is not being examined, control is passed to operation 625 and the process 600 continues.

In an embodiment, operations 615 through 650 may run in a loop such that the loop iterates through all completion periods in the scenario.

The main purpose in the process 600 is to accumulate work through completion time until the completion percentage reaches 100%. During the holding phase, the tracking properties may be incremented while progressing through each completion period until the work completion percent of the period reaches 100%. The holding phase may comprise operations 610 through 625 until the work completion percent of the period reaches 100%. The process then advances into the release phase. The total number of work tracking field is equal to the WIP and backlog at the beginning of the particular completion period with the addition of works that arrived in the period. Knowing the total number of work available and the number of staff available, the number of work that can be worked produces two distinct situations: the total number of work is greater than the number of staff available, and the total number of work is less than the number of staff available.

Ina situation where the total number of work is greater than the number of staff available, only the portion of the total number of work in that particular completion period equivalent to the number of staff available can be worked. Because only a portion of work can be worked, the number of WIP equals the greater of the number of WIP in the previous period and the number of staff available in the current period. Thus,

WIPⱼ=Max(WIPⱼ₋₁,#Staffⱼ)

The amount of WIP completed comprises the number of work that can be worked multiplied by the throughput rate

$$( \frac{1}{Handle Time} ) .$$

### Thus,

$$Amount of WIP {Completed}_{j} = \# {Staff}_{j} \times ( \frac{1}{Handle {Time}_{j}} )$$

In a situation where the total number of work is less than the number of staff available, all portions of the total number of work in that particular completion period can be worked. The number of WIP is thus equal to the total number of work in the system such that:

WIP=Total Number of Workⱼ

The amount of WIP completed comprises the number of work that can be worked multiplied by the throughput rate

$$( \frac{1}{Handle Time} ) .$$

### Thus,

$$Amount of WIP {Completed}_{j} = Total Number of {Work}_{j} \times ( \frac{1}{Handle {Time}_{j}} )$$

Once the total number of work is determined, the number of WIP, and the amount of WIP completed, updates to the backlog may be made and the total amount of WIP completed and the work completion percentage can be determined.

The backlog may be determined by subtracting the number of WIP from the total number of work. The work completion percentage may be determined by adding the throughput rate of the current completion period to the work completion percent of the previous period. The total amount of WIP completed may be determined by adding the amount of WIP completed of a completion period to the total amount of WIP completed in the beginning of that completion period.

In an embodiment, during the release phase of process 600, the tracking properties are collected and used to determined relevant service performance. The required updates and reset of tracking properties to progress the subsequent completion periods may be described as follows: when work completion percentage reaches 100%, it is assumed that the number of work completed is equal to the total amount of WIP completed and is released form the system. Thus, the number of WIP would decrease by the amount of total number of work completed. Lastly, the work completion percentage will be reset to 0% and the holding phase is restarted for the next set of completion period.

Given the total number of work completed for those completion periods where work completion percent is great or equal to 100%, a backtracking mechanism may be utilized to determine service performance. The number of deferred work completed will equal the number of work completed for each backtracked arrival period and the number of backlog is equal to the number of work not started of each arrival period. The resolution time is determined by taking the difference of the period where work completion percent is 100% and backtracked to the total number of work in the previous arrival period. From the resolution time, the maximum resolution time, average resolution time, and the average wait time can be determined through aggregation. Occupancy of each completion period may be determined by the amount of unassigned throughput versus the original available throughput.

### Deferred Work Staffing Requirement Generation

In an embodiment, staffing requirements are determined from input such as volume offered, expected handle time distributed throughout the intervals over a period of time, and one or more service performance goal(s). A staffing requirement generator may be used to output the staffing requirements by controlling backlog dynamically in such a way that the staffing requirement period-by-period is relatively steady (i.e., less fluctuating) while achieving the most optimal service threshold. Forecast input fluctuations, historical inefficiencies in staffing and handle time, and volume arrival patterns, among other factors, are accounted for and considered.

The appropriate level of staffing occupancy may also be controlled by making sure that the staffing requirement generator evaluates future incoming volume and the backlog from the previous period(s) and automatically restricts staffing requirements that yield low occupancy/efficiency. The required inputs, service performance goal, constraint parameter(s), detailed processes, and output of the requirement generator are further described below.

In an embodiment, the deferred work staffing requirement generation engine utilizes the deferred work performance simulation module previously described herein to search for the required number of staff given a set of inputs, performance goal desired and other constraint parameters. The engine may be applied for all of the periods of a planning scenario, such as planning for staffing for the next year, or selected set(s) of periods. Planning for a selective set of periods is useful in scenarios when optimal staff is needed in some periods but staff cannot be adjusted in other periods based on customer preference or limitations (e.g. hiring freeze constraint, ever-changing overtime policy, etc.). Further what-if scenarios may be examined by providing different set(s) of period ranges to the system.

Inputs needed for the requirement search engine may include, but not be limited to: number of deferred work volume, average elapsed time of deferred work (AET), average effective handle time of deferred work (AHT), number and age of initial backlog, initial staff, and input distributions.

The number of deferred work volume comprises the total number of deferred work offered to a queue. The AET comprises the average amount of elapsed time it takes a deferred work to be completed once it is being worked, including any delays and non-active agent times between the start and completion of a deferred work. The AHT comprises the average amount of work time it takes an agent to complete a deferred work. It should be noted that the AHT does not include any delays and non-active agent time between the start and completion of a deferred work.

The number and age of initial backlog comprises the initial backlog (the amount of unfinished deferred work) in the system at the beginning of the planning scenario. The age (how long the work has been waiting in the system) of each of those backlogs is needed for accurate determination of performance metrics. The initial staff comprises the initial staff that exist in the system at the beginning of the planning scenario. This parameter may be used initially in the search process. If not provided, the search may begin from the steady state staff value determined as part of the constraint parameter as discussed below. The input distributions comprise a set of factors for each time interval of a collection of time period that defines the typical distribution of intervals input throughout a time period. The input distributions may be used to distribute inputs to the same level of the granularity of the performance metric sought using the deferred work performance simulation module.

The deferred work staffing requirement generation engine generates several outputs which may include, but not be limited to, staffing requirement and performance metrics. The staffing requirement may be determined at the most granular level at which the requirement engine and the performance simulation module are set to. Further aggregation may be done to report the staffing requirement at different levels of granularity (i.e. number of full-time-equivalent staff for a week, number of headcount for a day, etc.). Because the requirement search engine utilizes the performance simulation module to determine performance of each requirement, these performance metrics are inherently the same as those from the performance simulation module. The performance metrics comprise: deferred work completed, maximum resolution time, average resolution time, average wait time, backlog, and occupancy.

A user of the system may determine performance goals that they desire in a planning scenario. These parameters may be set by the user, describing the performance desired by the user at which the requirement search engine will attempt to find a reasonable staffing requirement to meet. Where more than one performance goal is specified, the requirement search engine determines a staffing requirement that satisfies the entire goal. Some of the goal might be over achieved given the requirement, but this is done to satisfy the other more constraining goal(s).

Constraint parameters comprise optimizing parameters used throughout the engine while searching for the most balanced solution. A balanced solution comprises a solution that meets all performance goals as well as possesses the most steady staff level consistency. A solution quality score may be determined based on the staff consistency and goal achievement and the final solution with the best score is chosen at the end of the search process.

In order to determine the solution quality score, two properties are examined that are aggregated into a to-be-maximized fitness value: periodic goal hit score and staff consistency score. The periodic goal hit score evaluates the percentage difference between the performance and its intended goal. When performance is achieving or overachieving the target goal, then, depending on how far away from the target goal, the function yields a different value with the highest value assigned when it is closest to the goal. In an embodiment, if the performance does not achieve the target goal, then the score becomes zero. Thus,

$${Score ( performance metric )}_{i} = \{ \begin{matrix}\frac{calculated {performance}_{i}}{{Goal}_{i}} , achieve or overacheiving {Goal}_{i} \\ 0 , do not achieve {Goal}_{i}\end{matrix} \}$$

The ratio becomes

$$\frac{{Goal}_{i}}{calculated {performance}_{i}}$$

where performance metrics should be of a higher numerical value to hit a goal. The periodic goal hit score becomes the sum of all scores of every performance metric for all the periods, such that:

Periodic Goal Hit Score=Σᵢ₌₁ⁿScore(performance metric)ᵢ∀performance metric

where n represents the number of periods and i represents the i^{th} period starting from i=1.

The staff consistency score evaluates the staffing difference with respect to steady state staff spanning all periods as well as the staffing difference between ratios of staffing of each two consecutive periods. First, inconsistency is evaluated between staff requirements and its steady-state equivalent among all periods. The base of the comparison comprises the average staff ratio which represents the overall average gap between calculated staff requirement and steady state staff requirement of all periods such that:

$$Average Staff Ratio = \frac{1}{n} \times {\sum }_{i = 1}^{n} ( \frac{calculated {requirement}_{i}}{steady state {requirement}_{i}} )$$

where n represents the number of periods, i represents the i^{th} period starting from i=1.

To determine the distance or gap of each individual period, the difference between the average staff ratio and the ratio of calculated requirement versus steady state requirement is determined for each period. The ratios for those periods that are below the average staff ratio are not included in the final consistency ratio because the motivation is to minimize those periods where ratios are above the average staff ratio. Even though those periods that are below are not included, by minimizing periods which have higher ratios effectively pushes the periods which are lower to a higher value while still providing the same average staff ratio. Each of the period ratios approaches the average staff ratio, thus:

Total Staff Difference Ratio=ΣStaff Difference Ratioᵢ∀i where Staff Difference Ratioᵢ>0

The staff difference, which is the gap between the ratios of determined staff requirement versus steady state requirement between two consecutive periods, is determined:

$$Total Staff Difference = {\sum }_{i = 2}^{n} \vert \frac{calculated {requirement}_{i}}{steady state {requirement}_{i}} - \frac{calculated {requirement}_{( i - 1 )}}{steady state {requirement}_{( i - 1 )}} \vert$$

The total staff difference ratio and the total staff difference may be combined to form the final staff consistency score, where:

$$Staff Consistency Score = \frac{{( Total Staff Difference Ratio + Total Staff Difference )}^{2}}{{n}^{2}}$$

The final solution quality score thus becomes:

Final Solution Quality Score=Periodic Goal Hit Score+(100−Staff Consistency Weight×Staff Consistency Score)

where the staff consistency weight is (100/3).

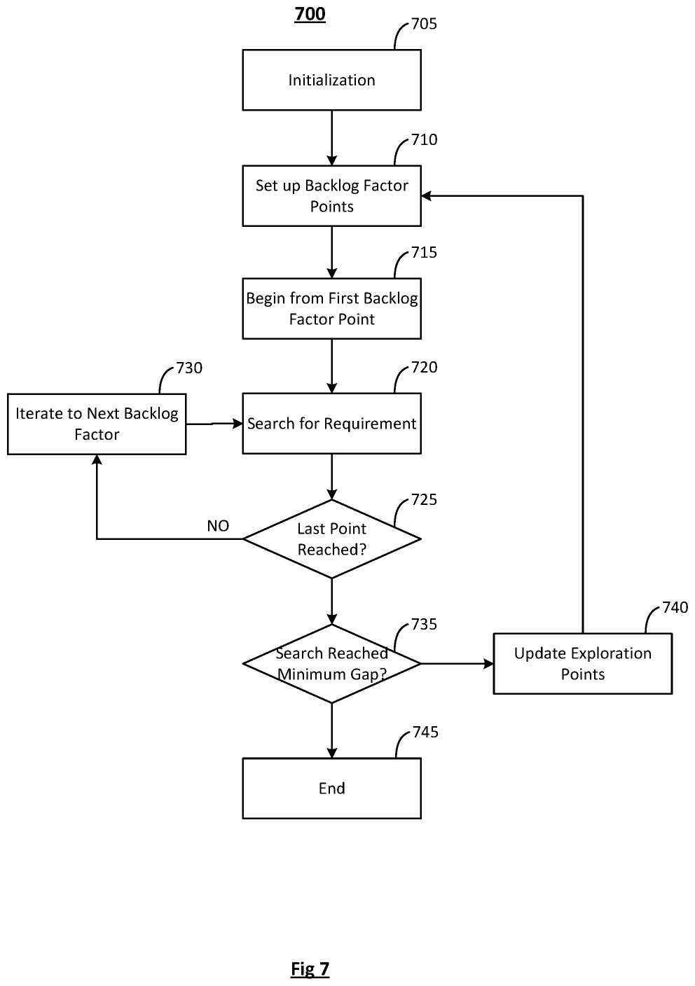

FIG. 7 is an embodiment of a process for deferred work requirement search, indicated generally at 700. This process may occur in the requirement generation engine of the Network Configuration Optimization System 205 (FIG. 2).

In operation 705, the engine is initialized. For example, inputs are gathered and transformed to fit into the engine, which includes applying distribution to adjust for the different levels of data granularity between sourced and planned output. Constraint parameters may be set to assist the engine with finding a balanced solution, such as steady-state staff and the minimum backlog control factor.

The minimum backlog control factor may be determined by capturing the variability of deferred work volume vs. staff availability. The volume arrived within the threshold period and the staff available to handle them are determined. Backlog equivalent is passed to the difference in staffing and volume during the threshold period, with the aim to minimally pass backlog. Once the minimum backlog control factor is determined, for each subsequent period (hour) or collection of period (days, week), the steady state backlog may be derived from the following:

$$Steady State {Backlog}_{i} = Minimum Backlog Control Factor \times {Volume}_{i + 1} \times \frac{Service Level Threshold}{Period Length}$$

The steady state backlog will be described in greater detail below in the process during the 9 point search.

Special treatment may be applied to the first and the last period of the planning horizon to adjust for unnecessarily overstaffing. Goals that are deemed unachievable are replaced by the maximum achievable goal equivalent. Control is passed to operation 710 and process 700 continues.

In operation 710, backlog factors are setup. For example, dynamic backlog search is performed. A multi-point determination may be used to determine the optimal percentage of backlog that should be passed from one period to another. In an embodiment, nine (9) points are searched for optimal solutions in order to explore and capture multiple nearby local optimal solutions. The points are added as a constraint parameter to the search to generate a staffing requirement. The points that generate the highest staff consistency and service level goal hit defined by the Solution Quality Score is further evaluated. Up to two (2) neighbors from either side of the best points may be selected for further exploration. The determination is repeated until the point distance becomes negligible and consistent backlog percentage across the planning scenario is achieved. As a result, the maximum number of periods achieving service level goals and high staff consistency are found. Control is passed to operation 715 and process 700 continues.

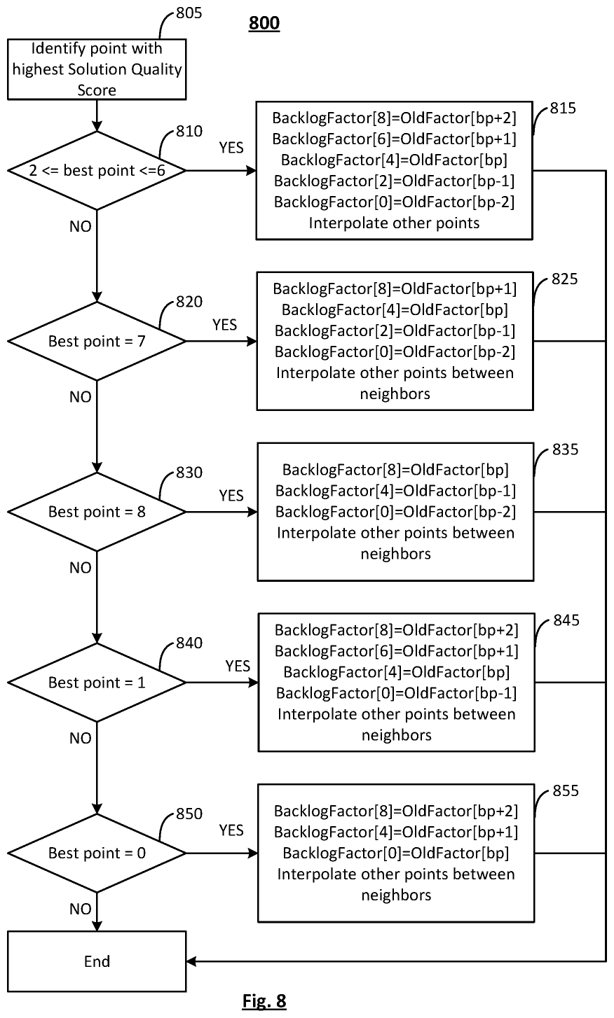

In operation 715, searching begins at the first backlog factor point. For example, the first point is equal to the Steady State Backlog and subsequent point is the multiplication of the steady state backlog with the multiplier equal to (1+3*i), where i represents the position of the points. New exploration points may be created and updated by interpolation based on the best point identified in pervious iterations with the highest Solution Quality Score. This is described in greater detail in FIG. 8 below. Control is passed to operation 720 and process 700 continues.

In operation 720, a search is performed for the requirement. For example, the engine searches for the staffing requirement for each of the backlog factors points defined in operation 715. Utilizing the deferred work simulation module, and beginning from the steady state staff, the engine will determine the staff required to meet each of the goal(s) and the constraint parameters defined in operation 705.

The staff Search direction determination comprises returns a requirement given the set of input and performance goal. The steady state staff is examined for a staff range that encloses the optimal solution, such as by examining small step sizes from the steady state staff, which that step size doubling until the staff range is found that encloses the optimal solution. A bisection algorithm may be used to pin down the optimal solution. Direction may change from iteration to iteration at any time. For each search result the required amount of staff or the sum of the required amount calculated is multiplied with staff or volume distribution if required and feedback to the Deferred Work Performance Simulator to provide performance metrics. By comparing those performance metrics to the goal, the search direction is determined. Feedback may be provided to the multi-point search determination, where the solution quality score is determined and further exploration is attempted. Control is passed to operation 725 and process 700 continues.

In operation 725, it is determined if the last point has been reached. If it is determined that the last point has been reach, control is passed to operation 735 and process 700 continues. If it is determined that the last point has not been reached, control is passed to operation 730 and process 700 continues.

In operation 730, the system iterates to the next backlog factor. Control is passed back to operation 720 and the process 700 continues.

In operation 735, it is determined if the minimum gap has been reached. If it is determined that the minimum gap has not been reached, control is passed to operation 740 and the process 700 continues. If it is determined that the minimum gap has been reached, control is passed to operation 745 and the process 700 ends.

The minimum gap comprises the precision set to terminate the search process. When the gap between the multi-points of the backlog factors is lower than this minimum gap, the process will end. The final staffing requirement and the service performance are reported.

In operation 740, the multi-point exploration points are updated. For example, the result from each of the points is evaluated by the engine. A solution quality score is determined for each solution from the multi-points. A new set of backlog factors are determined using one of the best solutions from the multi-points. The new set of factors are designed to hone in and narrow down the solution gap.

FIG. 8 is an embodiment of a decision tree for points exploration, indicated generally at 800. This process may occur in the requirement generation engine of the Network Configuration Optimization System 205 (FIG. 2). While a specific flow is illustrated here, this is just for example and is not the order that necessarily has to be followed with regards to updating points for future exploration.

In operation 805, the first point that provides the highest solution quality score is identified, as previously described. Control is passed to operation 810 and process 800 continues.

In operation 810, it is determined whether the best point is between points 2 and 6. If it is determined that the best point is between points 2 and 6, control is passed to operation 815 and process 800 continues. If it is determined that the best point is not between points 2 and 6, control is passed to operation 820 and operation 800 continues.

In operation 815, if it is determined that the best point is between points 2 to 6, then for the next iteration, the best point and its two neighbors are represented as points 0, 2, 4, 6, and 8, and the other points are interpolated. The process 800 ends.

In operation 820, it is determined whether the best point is 7. If it is determined that the best point is point 7, control is passed to operation 825 and process 800 continues. If it is determined that the best point is not point 7, control is passed to operation 830 and process 800 continues.

In operation 825, if the best point is point 7, point 7 becomes point 4 in the next iteration, and point 8 remains as point 8. Point 6 remains as point 2, point 5 as point 0, and the other points are interpolated. The process 800 ends.

In operation 830, it is determined whether the best point is 8. If it is determined that the best point is point 8, control is passed to operation 835 and process 800 continues. If it is determined that the best point is not point 8, control is passed to operation 840 and process 800 continues.

In operation 835, if the best point is point 8, point 7 becomes point 4, and point 6 becomes point 0, while the other points are interpolated. The process 800 ends.

In operation 840, it is determined whether the best point is 1. If it is determined that the best point is point 1, control is passed to operation 845 and process 800 continues. If it is determined that the best point is not point 1, control is passed to operation 850 and process 800 continues.

In operation 845, if the best point is point 1, then point 1 becomes point 4 in the next iteration, point 2 becomes point 6, point 3 becomes point 8 and point 0 remains 0. The other points are interpolated. The process 800 ends.

In operation 850, it is determined whether the best point is 0. If it is determined that the best point is point 0, control is passed to operation 855 and process 800 continues. If it is determined that the best point is not point 0, the process ends.

In operation 855, if the best point is 0, then point 0 becomes point 0, point 1 becomes point 4, and point 2 becomes point 8. The other points are interpolated. The process 800 ends.

The embodiments described herein have several applications, such as for long-term, strategic staff planning for deferred work such as E-mail, casework/back-office work, fax and voicemail work. In another application, deferred work routing systems in a multi-media contact center environment may be optimized. Individual agent's backlog levels can be dynamically determined so that the next work item is sent to the agent with the least workload and backlog at that moment. In terms of agent occupancy, the next deferred work would be sent to the agent who has been least occupied throughout the day.

In another application, outsourcing may be identified to achieve email/casework service level targets. In another application, such as in a multi-media/multi-skill environment, optimal allocation of staff between handling deferred work contact types versus immediate work contact types may be determined. During busy periods, more staff may be allocated to handling phone/chat contact types if they need more staff in order to achieve respective service goals. Optimization of when to re-allocate staff from Email/casework to phone/chat and how many staff should be re-allocated results.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for determining service performance metrics and assigning deferred work items by a workforce management system, the method comprising:
automatically sourcing data from an Automatic Communication Distributor at an interval of time,
wherein the interval of time comprises a handle time that is shorter than the interval of time, and
wherein if the sourced data are at different time interval levels, normalizing the sourced data to the same level;
iterating through the sourced data at the intervals of time to determine transient data;
applying the transient data to produce service performance metrics for the contact center using a backtracking calculation,
wherein a number of deferred work items completed for an interval of time is determined and number of deferred work items backlog for the interval of time is determined, and
iterating from an interval of time to a next interval of time is performed to determine resolution time for each deferred work item and a wait time for the deferred work item; and
assigning available deferred work items to available staff of the contact center with any unassigned work items added to a backlog queue such that a first deferred work item placed in the backlog queue is first to be assigned to an available staff.

2. The method of claim 1, wherein the interval of time comprises at least one of hourly, daily, weekly, and monthly.

3. The method of claim 1, wherein the service performance metrics comprise at least one of: deferred work items completed, maximum resolution time, average resolution time, average wait time, backlog, and occupancy.

4. The method of claim 1, wherein the backlog queue comprises work items which comprise at least one of: e-mail messages, e-mail inquiries, facsimile messages, insurance claims, and financial instruments.

5. The method of claim 1, wherein the iterating further comprises:
obtaining deferred work items completed from a first completed period and first arrival period;
subtracting completed work items from offered work items in the first arrival period;
determining at least one of: wait time and resolution time;
incrementing to a next arrival period if all work items offered are completed and incrementing to a next completed period if not all work items offered are completed, wherein if there is no next period, ending the process.

6. The method of claim 5, wherein the completed period comprises a period where work items are completed to one hundred percent (100%).

7. The method of claim 5, wherein the arrival period comprises a period where a work item first enters the workforce management system and has a completion rate of 0%.

8. The method of claim 1, wherein the number of deferred work items backlog for the interval of time determination comprises tracking percentage completion of each deferred work item.

9. A method for determining service performance metrics and assigning deferred work items by a workforce management system, the method comprising:
automatically sourcing data from an Automatic Communication Distributor at an interval of time,
wherein the interval of time comprises a handle time that is shorter than the interval of time, and
wherein if the sourced data are at different time interval levels, normalizing the sourced data to the same level;
iterating through the sourced data at the intervals of time to determine transient data;
applying the transient data, to produce service performance metrics for the contact center using a backtracking calculation,
wherein a number of deferred work items completed for an interval of time is determined and number of deferred work items backlog for the interval of time is determined, and
iterating from an interval of time to a next interval of time is performed to determine resolution time for each deferred work item and a wait time for the deferred work item; and
assigning available deferred work items to available staff of the contact center with any unassigned work items added to a backlog queue such that the assigning comprises assigning deferred work items with a lowest completion percentage first from the backlog queue.

10. The method of claim 9, wherein the service performance metrics comprise determining a number of deferred work items for an interval time, wherein the determining comprises tracking percentage completion of each deferred work item at an interval period level.

11. The method of claim 10, wherein the determining further comprises adding a completion percentage to each period depending on available staff and throughput rate of the available staff and determining the performance of released completed work according to the period interval using tracking properties until completion of a deferred work item achieves one hundred percent (100%).

12. The method of claim 11, wherein the tracking properties further comprise: number of work items in progress, number of work items not started, total number of work items, work completion percentage, amount of work items in progress completed, and total amount of work items in progress completed.

13. The method of claim 9, wherein the interval of time comprises at least one of: hourly, daily, weekly, and monthly.

14. The method of claim 9, wherein the service performance metrics comprise at least one of: deferred work items completed, maximum resolution time, average resolution time, average wait time, backlog, and occupancy.

15. The method of claim 9, wherein the backlog queue comprises work items which comprise at least one of: e-mail messages, e-mail inquiries, facsimile messages, insurance claims, and financial instruments.

16. The method of claim 9, wherein the iterating further comprises:
obtaining deferred work items completed from a first completed period and first arrival period;
subtracting completed work items from offered work items in the first arrival period;
determining at least one of: wait time and resolution time;
incrementing to a next arrival period if all work items offered are completed and incrementing to a next completed period if not all work items offered are completed, wherein if there is no next period, ending the process.

17. The method of claim 16, wherein the completed period comprises a period where work items are completed to one hundred percent (100%).

18. The method of claim 16, wherein the arrival period comprises a period where a work item first enters the workforce management system and has a completion rate of 0%.
